(19) United States
(12) Patent Application Publication
(10) Pub. No.: US 2008/0126683 A1
(43) Pub. Date: May 29, 2008

(54) MEMORY SYSTEM

(76) Inventor: Hidetaka Tsuji, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/768,464

(22) Filed: Jun. 26, 2007

(30) Foreign Application Priority Data
Jun. 27, 2006 (JP) 2006-176798

(51) Int. Cl. G06F 12/02

(52) U.S. Cl. 711/103; 711/101; 711/E12.008

(57) ABSTRACT

A memory system is configured to receive write data each labeled with a logical address from a host device and includes a nonvolatile semiconductor memory and a controller. The memory stores data in units of a first unit area and erases data in units of a second unit area, each of second unit areas consists of a predetermined number of first unit areas. The controller classifies the logical address of the write data into one of management units in accordance with the logical address, manages correspondence information that shows a correspondence between logical addresses of stored data and second unit areas that store corresponding write data for each of the management units, and assigns to the write data one of the second unit areas that have at least as large address space as an address space of logical addresses belonging to two or more of the management units.

### CROSS-REFERENCE TO RELATED APPLICATIONS

This application is based upon and claims the benefit of priority from prior Japanese Patent Application No. 2006-176798, filed Jun. 27, 2006, the entire contents of which are incorporated herein by reference.

### BACKGROUND OF THE INVENTION

1. Field of the Invention

The present invention relates to assignment of a storage area of a flash memory to write data by a controller that controls the memory in a memory system.

2. Description of the Related Art

A memory card is one of removable storage devices and recently used in electronic devices such as personal computers, personal digital assistants and cellular phones. The memory card has, for example, a NAND type flash memory and a controller to control the memory. A storage unit of the NAND type flash memory is called a page that has predetermined storage capacity. Data in the pages are erased in units of a block that consists of pages.

For writing data into the memory card by a host device, a file system in the host device divides write data into predetermined-size pieces of data and assigns a logical address to each piece of data. Then, the host device supplies the controller of the memory card with the write data and logical addresses.

The controller receives a write command, write data and a logical address and writes the write data into one or more appropriate unused blocks in the NAND type flash memory. The controller creates a table to manage a correspondence between the logical addresses of write data and addresses of pages in the block which contain the write data when writing. Actually, writing is performed in units of the block and a correspondence table for a correspondence between logical addresses and physical addresses of blocks is created.

The correspondence table between logical addresses and physical addresses is called, for example, a logical address/physical address conversion table (hereinafter referred to as a logical-to-physical table). The table is created on a random access memory in the controller.

In the NAND type flash memory, overwriting of data in pages is prohibited. Therefore, data is always written into unused blocks and the controller uses an unused block table, which helps the controller identify unused blocks. The unused table also stays on the RAM.

The logical-to-physical table and the unused block table are, for example, written into the NAND type flash memory before the power to the memory card is cut off and the like. When the NAND type flash memory already stores the logical-to-physical table, the controller reads it from the NAND type flash memory onto the RAM.

### BRIEF SUMMARY OF THE INVENTION

According to an aspect of the present invention, there is provided a memory system that is configured to receive write data each labeled with a logical address from a host device, the system comprising: a nonvolatile semiconductor memory storing data in units of a first unit area and erasing data in units of a second unit area, each of second unit areas consisting of a predetermined number of first unit areas; a controller classifying the logical address of the write data into one of management units in accordance with the logical address, managing correspondence information that shows a correspondence between logical addresses of stored data and second unit areas that store corresponding write data for each of the management units, and assigning to the write data one of the second unit areas that have at least as large address space as an address space of logical addresses belonging to two or more of the management units.

According to anther aspect of the present invention, there is provided a memory system that is configured to receive write data each labeled with a logical address from a host device, the system comprising: a nonvolatile first semiconductor memory and a nonvolatile second semiconductor memory each storing data in units of a first unit area and erasing data in units of a second unit area, each of second unit areas consisting of a predetermined number of first unit areas; and a controller assigning to the write data one of the second unit areas that belong to only one of the first semiconductor memory and the second semiconductor memory determined in accordance with the logical address of the write data and that have at least as large address space as an address space of logical addresses belonging to two or more of the management units.

According to still another aspect of the present invention, there is provided a memory system that is configured to receive write data that contains actual data or management data to manage actual data and is labeled with a logical address from a host device, the system comprising: a nonvolatile semiconductor memory storing data in units of a first unit area and erasing data in units of a second unit area, each of second unit areas consisting of a predetermined number of first unit areas; and a controller assigning to the write data one of the second unit areas that contain no valid data and creating a management data correspondence information that shows correspondence between logical addresses of stored data containing the management data and second unit areas that store corresponding data containing the management data.

### BRIEF DESCRIPTION OF THE SEVERAL VIEWS OF THE DRAWING

FIG. 1 illustrates zone management.

FIG. 2 shows a schematic configuration of a memory system according to embodiments of the present invention.

FIG. 3 is a block diagram which shows a hardware configuration of the memory system of embodiments of the present invention.

FIG. 4 shows a structure of data storage area of a flash memory.

FIG. 5 shows a state of the memory system during writing by a memory system according to a first embodiment.

FIG. 6 shows a state of the memory system succeeding to the state shown in FIG. 5.

FIG. 7 shows a state of the memory system succeeding to the state shown in FIG. 6.

FIG. 8 shows a state of the memory system succeeding to the state shown in FIG. 7.

FIG. 9 shows a state of the memory system succeeding to the state shown in FIG. 8.

FIG. 10 shows a flowchart of writing of the memory system according to the first embodiment.

FIG. 11 shows a state of the memory system during writing by a memory system according to a second embodiment.

FIG. 12 shows a state of the memory system succeeding to the state shown in FIG. 11.

FIG. 13 shows a state of the memory system succeeding to the state shown in FIG. 12.

FIG. 14 shows a flowchart of writing operation of the memory system according to the second embodiment.

FIG. 15 shows a state of the memory system during writing by a memory system according to a third embodiment.

FIG. 16 shows zones and frequent-access areas.

FIG. 17 shows a state of the memory system during writing by a memory system according to the third embodiment.

FIG. 18 shows a flowchart of writing operation of the memory system according to the third embodiment.

### DETAILED DESCRIPTION OF THE INVENTION

Consolidate management with the logical-to-physical table and the unused block table for all logical addresses and all physical addresses requires a RAM with a huge capacity in the controller. Providing a RAM with a capacity large enough to contain all data required for the management is difficult due to restrictions by cost and is more difficult in the NAND flash memory with a larger capacity. The problem may be overcome by a technique called zone management. The zone management involves using only a correspondence between some logical addresses and physical addresses.

Zone management manages more than one logical address and more than one physical address as one unit. Explanation of zone management will be given with reference to a memory card that has two NAND type flash memories 102 and 103 and a controller as an example. Each flash memory 102 and 103 has M blocks. Each block consists of pages as mentioned above. Memory area of each flash memory is divided into zones. Assume that each zone consists of M/2 blocks.

Assume that block addresses 0 to (M/2)−1 and block addresses M/2 to M of the flash memory 102 belong to zone 0 and zone 1, respectively. Similarly, block addresses 0 to (M/2)−1 and block addresses M/2 to M of the flash memory 103 belong to zone 2 and zone 3, respectively. Which zone blocks of flash memories 102 and 103 belong to is determined in accordance with their respective physical addresses.

Which zone each piece of data to be written is written to is also determined in accordance with its logical address by controller 104. For example, pieces of data of consecutive logical addresses are dealt with as one zone and they are written into a corresponding unique zone in the flash memory.

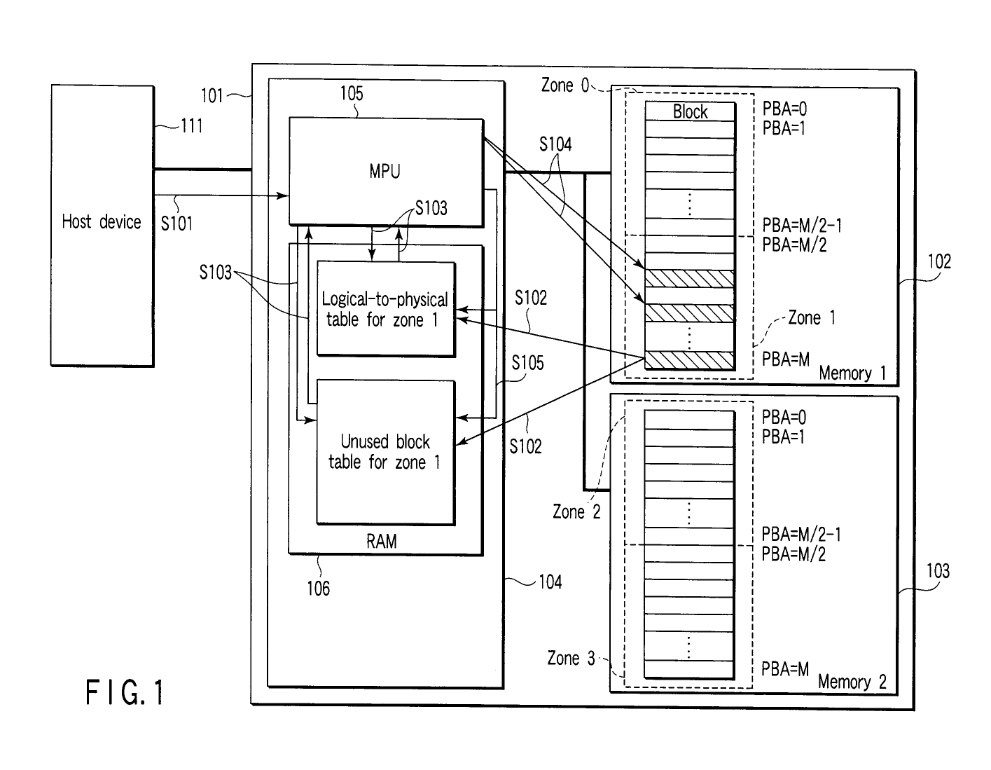

FIG. 1 shows writing operation using the zone management. The controller 104 receives write data and its logical address (step S1).

Then, a micro processing unit (MPU) 105 in the controller 104 uses the logical address to learn which zone the logical address belongs to (for example, zone 1). A program to control the MPU 105 is configured to enable the controller to write the write data with a logical address that belongs to zone 1 into zone 1 in the flash memory 102 and 103. Therefore, the MPU reads out the logical-to-physical table and an unused block table for zone 1, to which the write data belongs, onto the RAM 106 (step 102). The logical-to-physical table is created for each zone and stored in respective zone.

The MPU 105 refers to the unused block table for a zone to which the write data belongs to identify unused blocks (step S103). Then, the MPU 105 writes the write data into an unused block in zone 1 (step S104). The MPU 105 updates the logical-to-physical table and the unused block table to reflect the writing (step S105).

When writing operation, the host device provides the MPU 105 with a logical address of read data. The MPU 105 uses the logical address of the read data to learn which zone the read data belongs to. A logical-to-physical table for a zone to which the read data belongs is read out onto the RAM 106 from the corresponding zone of the flash memory 102 or 103. Then, the MPU 105 refers to the logical-to-physical table for the zone of the flash memory 102 or 103 which corresponds to the zone to which the read data belongs and reads out the read data from a block which stores the read data.

Zone management only requires reading of a logical-to-physical table for a target zone for writing and reading. This demands smaller RAM capacity than a logical-to-physical table for all logical addresses on RAM does.

The aforementioned zone management, however, may cause the following phenomenon in some usages of memory card by a user. Using a memory card with 1 GB capacity in a digital camera will be taken as an example. Under the condition, a possible usage is a repeat of storing image data of 100 MB size into the memory card, transferring the data to another device (for example, a personal computer), and erasing the data from the memory card.

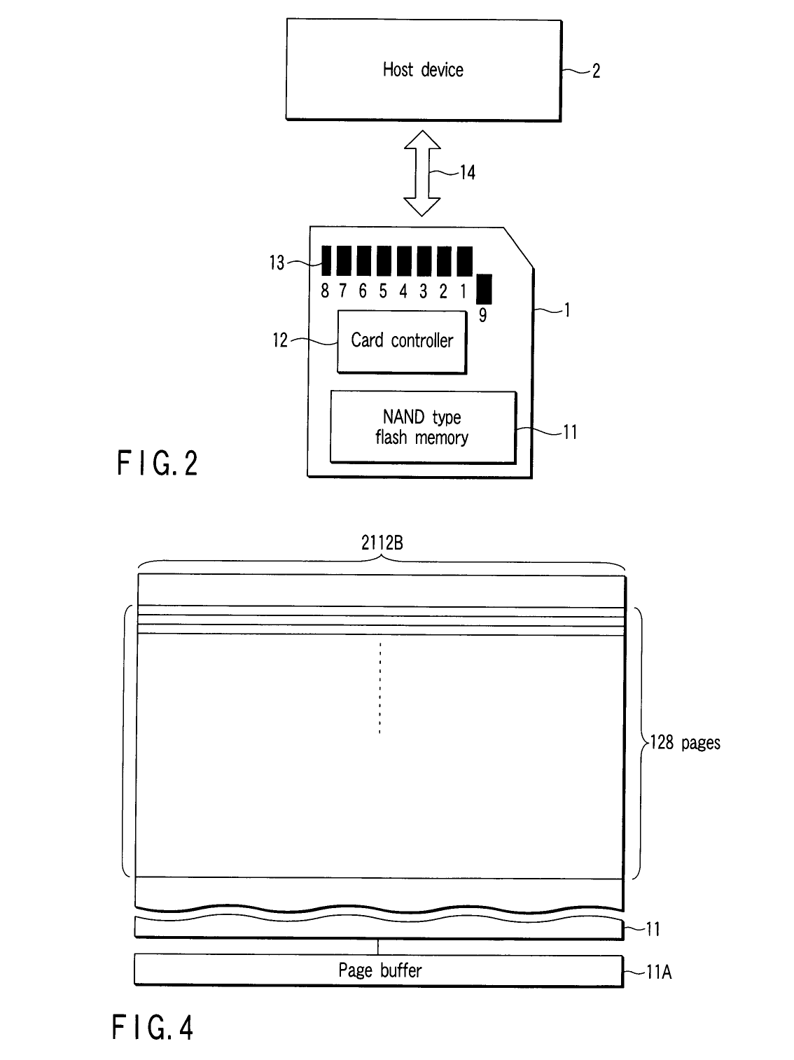

The usage assigns low number logical addresses to write data every time, which corresponds to writing of the 100 MB data in zone 0 in an example of FIG. 2. Block addresses 0 to (M/2)−1 are assigned to zone 0 as mentioned, resulting in seldom usage of blocks in other zones.

Another possible phenomenon in some file systems employed by the host device is as follows. A file system information used by a file system needs to be updated along with data writing. A widely-used FAT file system assigns the lowest-number logical addresses to the file system information, resulting in writing of the file system in zone 0. Since the file system information is frequently updated, the result is frequent writing into zone 0.

Frequent writing into a fixed zone in a flash memory means repeated writing into blocks in the corresponding zone. Pages in the flash memory have respective limits for the number of writing imposed by characteristic degradation. Heavily-repeated writing in the same blocks in the flash memory exceeds the limit much earlier than in other blocks. This disables the memory card including such blocks even if other blocks are available for writing when the zone management is employed.

The following phenomenon may occur due to accesses for updating the file system information, which is inevitable after writing. That is, when write data and the file system information belong to different zones, different logical-to-physical tables need to be read out and written each time writing is performed and the file system information is updated. This results in longer writing time in the memory card.

A description will be given of embodiments of the present invention with reference to drawings. In the following description, the same reference numerals will be labeled to the features having similar functions and configurations, and repeated descriptions will be given only when necessary.

Memory cards will be taken as examples of memory systems of the embodiments of the present invention.

### (Description Common to all Embodiments)

FIG. 2 schematically shows a configuration of a memory card. A memory card of each of following first to third embodiments has a configuration which is shown in FIG. 2 to FIG. 4 and described with reference to the figures.

As shown in FIG. 2, the memory card 1 has a NAND type flash memory chip (hereinafter simply referred to as a flash memory) 11, a card controller 12 to control the flash memory 11 and signal pins (first to ninth pins) 13.

The memory card (memory system) 1 uses a host interface 14 to send and receive signals to and from a host device 2. The memory card 1 is electrically connected to the host device 13 via the signal pins 13.

The signal pins 13 are electrically connected to the card controller 12. The signal pins 13 include the first to ninth pins. For example, data zero to data three, a card detection signal, commands, a ground potential Vss, a power potential Vdd and a clock signal are assigned to the first to ninth pins.

The memory card 1 is adapted to be inserted and removed to and from a slot provided in the host device 2. The host device 2 uses the first to ninth signal pins to transfer various signals and data with the card controller 12. The host device 2, for example, sends commands as serial signals to the card controller 12 via the signal pins 13. The card controller 12 takes in the commands and data in accordance with the clock signal provided via the signal pins.

On the other hand, communication between the flash memory 11 and the card controller 12 is carried out via interface for the NAND type flash memory. More specifically, the flash memory 11 and the card controller 12 are connected via parallel 8-bit input-output (I/O) lines (not shown). For example for writing, the card controller 12 uses the I/O lines to output a data input command, a column address, a page address, data, and a program command one after another to the flash memory 11.

How signals are assigned to signal pines depends on an operation mode of the memory card 1. The operation mode is, in general, an SD mode or an SPI mode. In the SD mode, the memory card 1 is further set to SD 4-bit mode or SD 1-bit mode via a bus change command provided from the host device 2. In the SD mode, the signal pins 13 are used for commands/responses and a clock signal.

In the SD 4-bit mode, data is transferred in units of four bits via four of the signal pins 13. In the SD 1-bit mode, data is transferred in units of one bit via one of the signal pins 13, and the remaining three pins that are used in the SD 4-bit mode are not used.

In the SPI mode, one of the signal pins 13 is used as a data signal line from the memory card 1 to the host device 2, another one of the signal pins 13 is used as a data signal line from the host device 2 to the memory card 1. Still another one of the signal lines 13 is used to send a chip select signal from the host device 2 to the memory card 1.

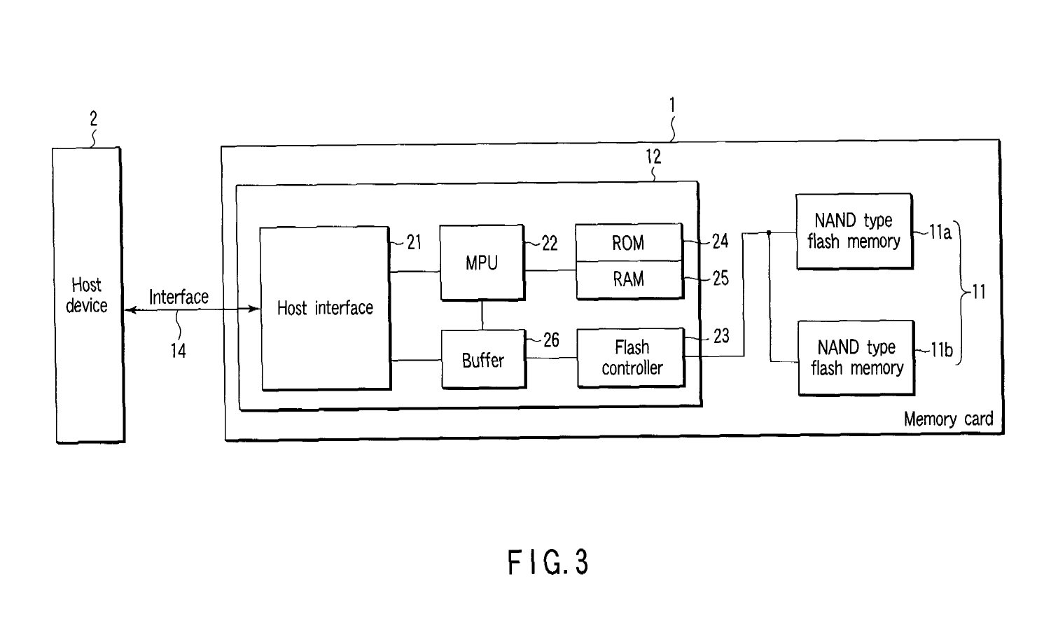

FIG. 3 is a block diagram showing a hardware configuration of the memory card of each embodiment of the present invention.

As shown in FIG. 3, the host device 2 has hardware and software to access the memory card 1 via the interface 14. When connected to the host 2, the memory card 1 is supplied with power to operate and execute processes in accordance with instructions from the host device 2.

The memory card 1 includes the flash memory 11 and the controller 12 as described above. The size of each erase unit (block) of the flash memory is defined and may be 256 kB. Data write and read are performed in the flash memory in a predetermined size (for example 2 kB) unit, which is called a page.

The flash memory 11 may have more than one NAND type flash memory 11 (11a, 11b) to have larger storage capacity if required. FIG. 3 illustrates that the flash memory 11 has two NAND type flash memories. Using more than two NAND type flash memories is also possible.

The card controller 12 manages an internal physical state of the flash memory 3 (for example, it manages which logical sector address a physical block stores, and which block is erased). The controller 12 also determines which block should contain write data identified by a logical address (or which block should be assigned for storing data identified by a logical address).

The card controller 12 includes, for example, a host interface module 21, a micro processing unit (MPU) 22, a flash controller 23, a read only memory (ROM) 24, a random access memory (RAM) 25, and a buffer 26.

The host interface module 21 performs an interface process between the controller 12 and the host device 2. As for a hardware configuration, the host interface module 21 has signal pins 13 as described above.

The host interface module 21 includes various registers. The registers store, for example, error information, an identification number of the memory card 1, a relative card address, which the host device dynamically assigns on an initialization, a bus-drive-power value of the memory card 1, characteristic parameters of the memory card 1, data layout of the memory card 1, and operation voltage of the memory card that has limited operation voltage.

The MPU 22 is responsible for operations of the whole memory card 1. The MPU 22 loads firmware (control program) stored in ROM 24, into RAM to execute a predetermined processes when, for example, the memory card 1 is powered on. MPU 22 follows the control program to create various tables on RAM 25.

The MPU 22 receives write commands, read commands, and erase commands from the host device 2 to execute predetermined processes on the flash memory 11 or to control a data transfer process through the buffer 26.

ROM 24 stores, for example, control programs to control MPU 22. RAM 25 is used as a work area for MPU 22 to store control programs and various tables. The flash controller 23 executes an interface process between the card controller 12 and the flash memory 11.

The buffer 26 temporally stores a predetermined quantity of data (for example, 1 page) sent from the host device 2 or the flash memory 11.

FIG. 4 shows a structure of an area that the flash memory 11 uses to store data (a data storage area). Each page in the flash memory 11 has 2112 B (512 B×4 for data+10 B×4 for redundancy+24 B for management data). One erase unit (256 kB+8 kB (k being equal to 1024)) consists of 128 pages. The size of the erase unit may be 16 kB.

The flash memory 11 has a page buffer 11A used for inputting and outputting data to and from the flash memory 11. The page buffer 11A has a storage capacity of 2112 B (2048 B+64 B).

The data storage area of the flash memory may be divided into some smaller areas in accordance with kinds of data to be stored. The areas may include a management data area, a confidential data area, a protected data area, and a user data area.

The management data area stores card information such as security information and a media ID. The confidential data area stores key information for encryption and confidential data for authentication and cannot be accessed by the host device 2. The protected data area stores important data and can be accessed only after the host 20 is validated through a mutual authentication between the memory card 1 and the host 2 connected to the memory card 1. The user data area stores user data, and can be freely accessed and used by a user of the memory card 1. Hereinafter, pages and blocks are ones in the user data area unless otherwise indicated.

### First Embodiment

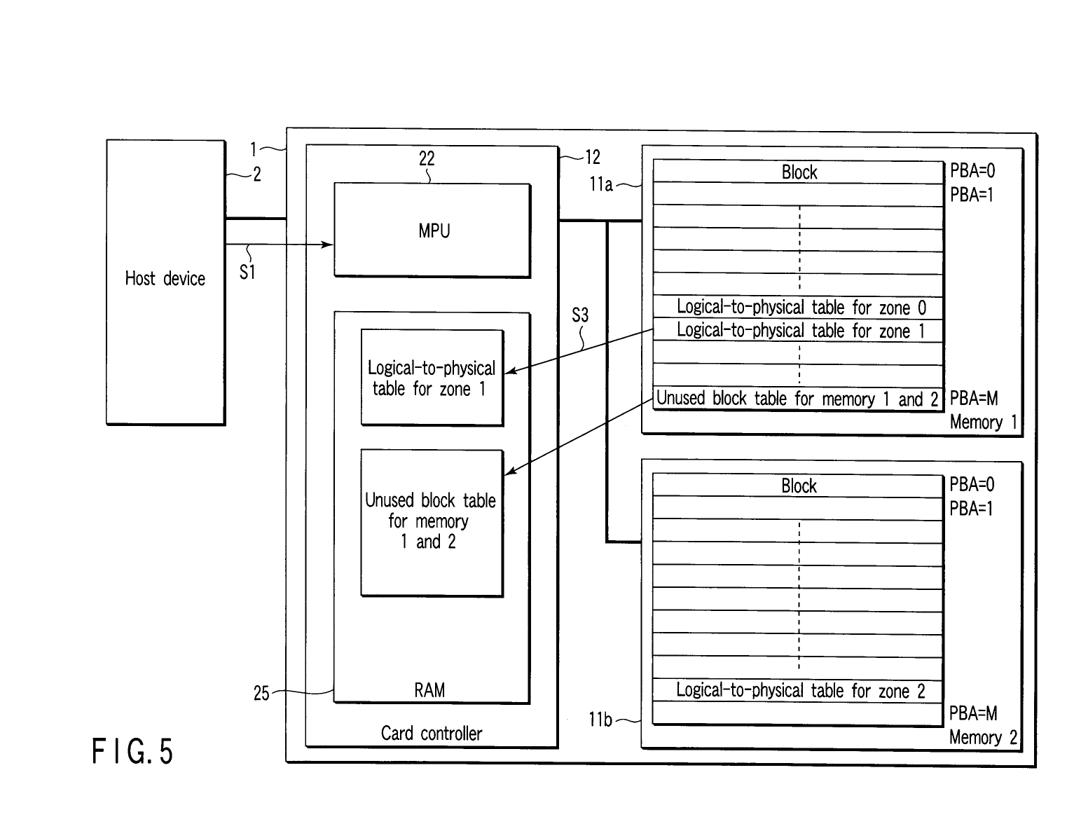

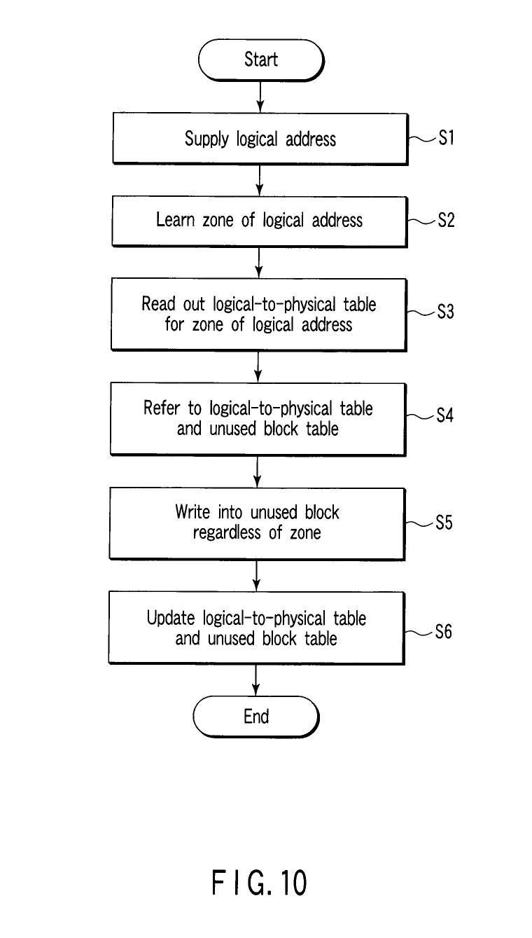

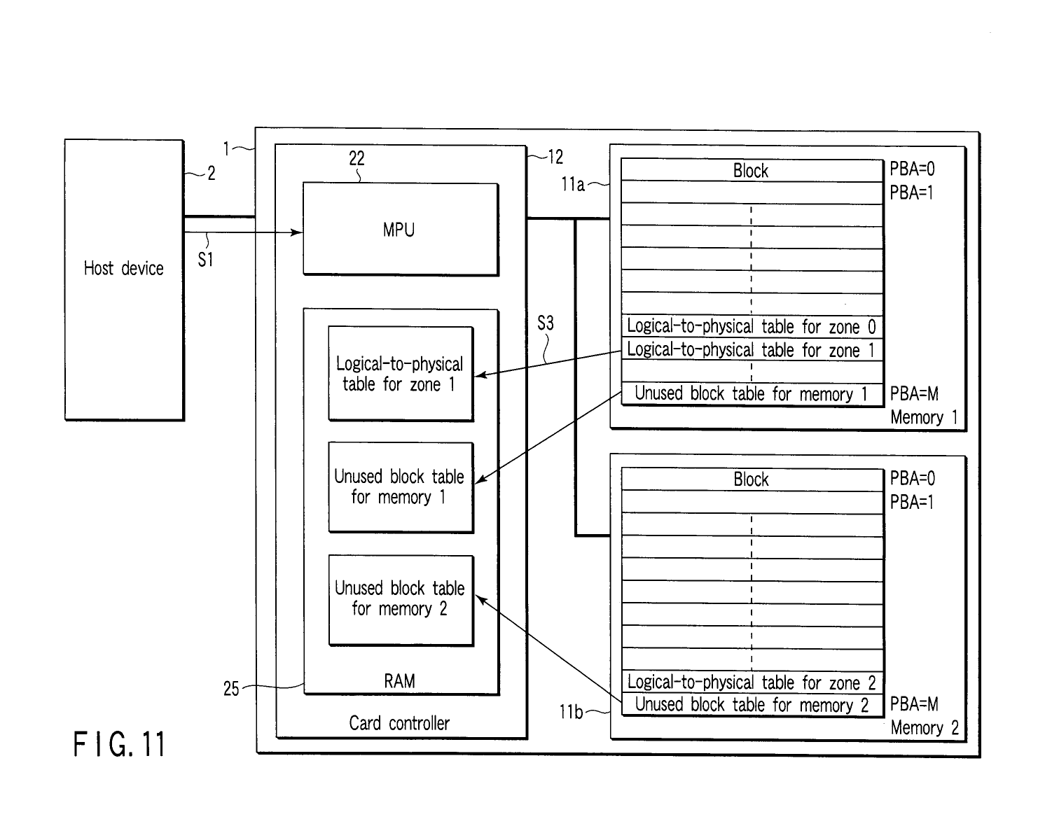

Referring to FIGS. 5 to 10, the first embodiment of a memory system (memory card) of the present invention will be described. FIGS. 5 to 9 are block diagrams each of which shows a state of the memory system (memory card) of the first embodiment during writing. FIG. 10 is a flowchart for writing of the memory card of the first embodiment. FIGS. 5 to 9 partly show components necessary for explanation of the first embodiment among those shown in FIG. 3.

Referring to FIGS. 5 to 10, the operation of the memory system of the first embodiment will be described. FIGS. 5 to 10 show that each flash memory 11a and 11b has M blocks each of which is identified by a unique physical block address (PBA). Flash memories 11a and 11b, however, may have different number of blocks.

As shown in FIGS. 5 and 10, the MPU 22 receives write data and its logical address from the host device 2 (step S1).

Then, the MPU 22 uses the logical address to learn a zone to which the logical address belongs (step S2). As for a correspondence between logical addresses and zones, a particular number of consecutive logical addresses can be defined as a zone. Similarly, each set of the same-number logical addresses forms a zone.

Then, the MPU 22 searches for an unused block to store write data. The unused block stores old data after update, stores no data after erasure, or has yet to store data.

There are some possible methods for searching for unused blocks. Using an unused block table is taken as an example. How to construct the unused block table may also vary.

The unused block table shows whether a block in the flash memories 11a and 11b is used or unused for each block. The unused block table covers all blocks in the flash memory 11a and 11b in the embodiment.

When the memory system 1 receives power from the host device 2 or receives the first write command after a start of application of power, the MPU 22 creates the unused block table on the RAM 25 before writing operation.

The unused block table may be moved from the RAM 25 to a particular area in the flash memory 11a and 11b (hereinafter collectively referred to as flash memory 11 except when individual identification is necessary) when the power to the memory system 1 is cut off and read it out on the resume of the power. In this case, each unused block table for each flash memory 11 may be stored in the corresponding memory 11. Any methods other than the mentioned one may also be used.

The MPU 22 also creates a logical-address/physical-address conversion table (logical-to-physical table) for the zone to which the logical address of the write data belongs on the RAM 25 (step S3). The logical-to-physical table shows which block stores valid (latest) data on one-to-one basis.

The logical-to-physical table is created when the MPU 22 is turned on, for example, in response to the initialization of memory system 1. More specifically, when initialization, MPU 22 checks all blocks in the flash memory 11 and uses attribution of data stored in the block to create the logical-to-physical table. The logical-to-physical table is stored into the flash memory 11 for example, when the power to the memory system 1 is cut off. Then, the MPU 22 reads out the logical-to-physical table for the logical address of the write data (target logical-to-physical table) from the flash memory 11 to use it. Alternatively, all blocks may also be checked to use attribution of data to create the logical/address table on each initialization.

Still alternatively, all blocks in the flash memory 11 may be checked to create the logical-to-physical table every time it is needed. That is, the present embodiment and a second and a third embodiment that follow do not care how to create the logical-to-physical table on the RAM 25.

When the logical-to-physical table for a different zone from the zone for the write data already exists on the RAM 25, the table is stored into the flash memory 11 before the target logical-to-physical table is created on the RAM 25.

On the other hand, the target logical-to-physical table is already on the RAM 25 to be used for preceding writing or reading, the reading of the table from the flash memory 11 is omitted.

As described, the logical-to-physical table is created, written into the flash memory 11, and read out from the flash memory 11 in units of a set of predetermined number of logical addresses which form a zone. For this reason, logical-to-physical tables for respective zones of write data are stored in the flash memory 11. The size of a zone is determined to allow the RAM 25 to hold the unused block table and the logical-to-physical tables which are created for respective zones.

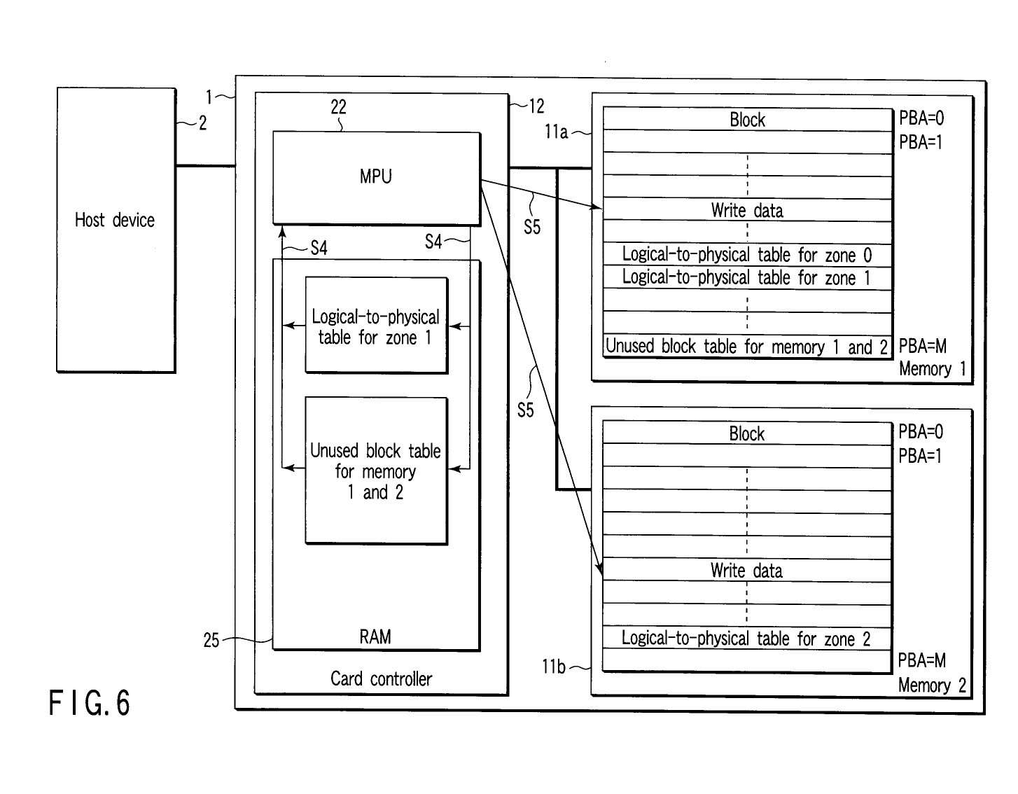

As shown FIGS. 6 and 10, the MPU 22 refers to the unused block table and the logical-to-physical table (step S4). Then, the MPU 22 assigns at least one unused block to the write data and executes operation to write the write data into the assigned block. In other words, MPU 22 accesses the unused block table and the logical-to-physical table created on the RAM 25, searches for an unused block, and learns an address of a found unused block. Then, the MPU 22 assigns the unused block or more blocks to write data in accordance with a size of the write data.

The unused block table covers usage state for all blocks in the flash memory 11a and 11b. For this reason, the MPU 22 uses up to all blocks as a candidate for writing. In other words, blocks of the flash memory 11 are not divided into zones. Therefore, the MPU 22 can use any unused block for assignment to write data.

Candidates of the unused blocks for assignment to the write data can also be explained as follows. As described above, when blocks are divided into zones corresponding to the zones of logical addresses, blocks for write data are to be selected from predetermined ones (ones belonging to the corresponding zone) which corresponds to a zone of the logical address of write data. Therefore, the number of blocks included in a zone corresponds to address space indicated by logical addresses included in the zone. For example, when the address space of logical addresses included in zone 1 is equal to 1000 physical blocks, one of 1000 blocks is used to store write data of a logical address which belongs to zone 1 (blocks for replacing bad blocks not being considered here)

On the other hand, block assignment is not affected by zones in the first embodiment. For example, when the address space of logical addresses which belong to zone 1 is equal to 1000 blocks, one of more than 1000 blocks, for example 2000 blocks, which is twice as large as the address space, is used to store write data with a logical address in zone1. That is, blocks to be assigned is searched for from blocks whose address space is as large as or substantially as large as that of logical addresses which belong to two zones.

Then, the MPU 22 instructs the flash memory 11 to write the write data into the assigned block. The flash memory 11 responds to that to write the write data into the designated block.

Note that when a write instruction from the host device 2 corresponds to overwriting of data of a certain logical address, an operation, which is called “copy-involved writing” etc., is performed. The copy-involved writing is needed due to a prohibition of overwriting in flash memories. The copy-involved writing performs writing of write data of the target logical address for update and data stored in the same block as the data with the target logical address into an unused block.

MPU 22 classifies logical addresses into zones to manage them, but does not classify blocks to manage them. In other words, blocks are not imposed restrictions to be selected to store the write data. For this reason, the MPU 22 can assign any unused block to write data. Therefore, even when writing of writing data with a particular logical address is frequently requested, writing into a fixed block is avoided to allow uniform usage of the memory space (user data area) of the flash memory 11.

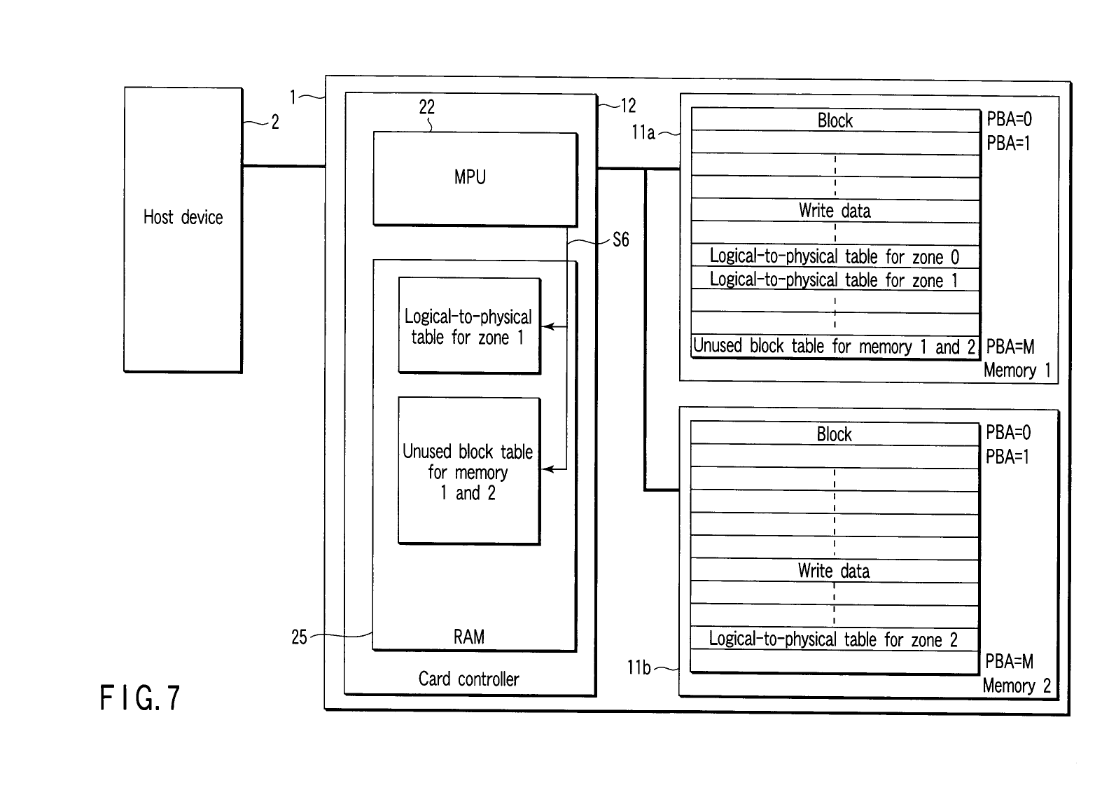

As shown in FIGS. 7 and 10, MPU 22 updates the target logical-to-physical table in accordance with the logical address of the write data (step S6). More specifically, the MPU 22 updates the block address for the logical address of the write data in the target logical-to-physical table. An unused block table is also updated to reflect the state exhibited after the write data is written.

In the foregoing description, the target logical-to-physical table is read out before assignment of unused block to write data. The MPU 22, however, may use only the unused block table to assign an unused block to write data before reading out the target logical-to-physical table on an update thereof.

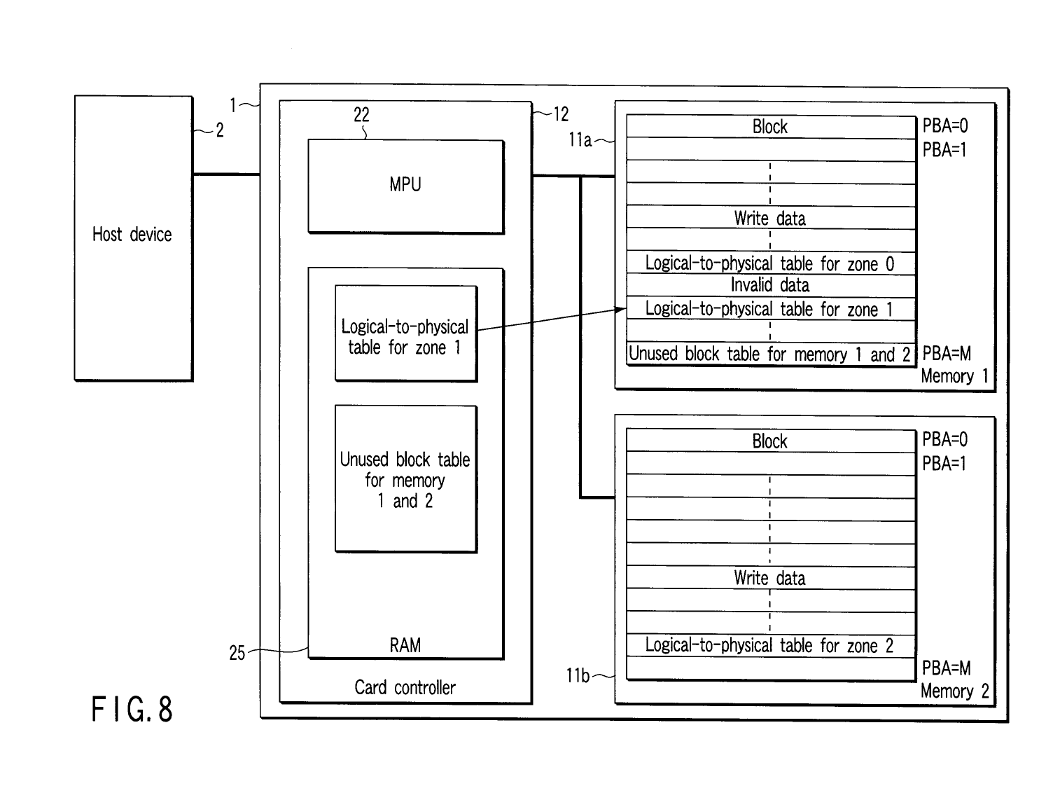

Then, as shown in FIG. 8, when writing data with a logical address belonging to another zone is requested, the target logical-to-physical table (the logical-to-physical table for zone 1) is written into an unused block. As a result, data for the pre-updated logical-to-physical table for zone 1 is no more valid. A block storing the invalid data is subsequently treated as an unused block. For this reason, invalid data and the unused block table due to update are erased, for example, after they turns into invalid or before writing into a block containing such blocks.

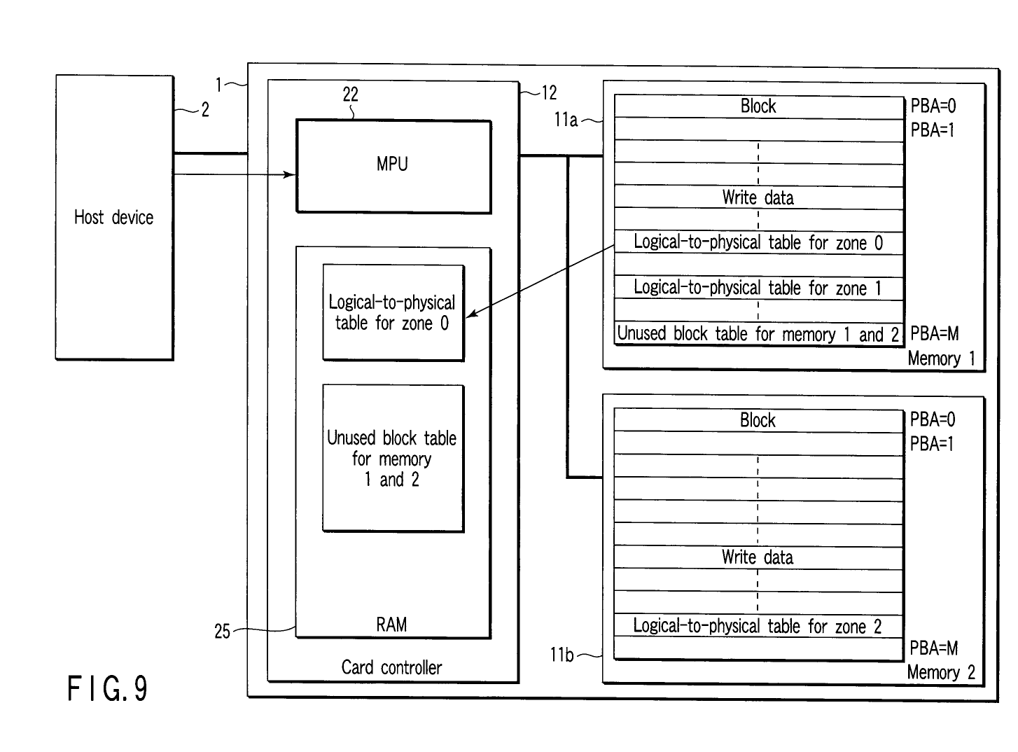

Then, as shown in FIG. 9, next write data is provided to MPU 22, and the logical-to-physical table for the zone (for example zone 0) of the write data is read out from the flash memory 11 to RAM 25.

The logical-to-physical table and the unused block table on RAM 25 are also written into the flash memory when, for example, the power to the memory system 1 is cut off.

Reading operation is performed as in the conventional fashion using conventional zone management. More specifically, the MPU 22 uses the logical address of the read data to learn the zone to which the read data belongs. Then, the MPU 22 reads out the logical-to-physical table for the zone to which the read data belongs from the flash memory 11 onto RAM 25. Then, the MPU 22 refers to the logical-to-physical table to learn the block which stores the read data and instructs the flash memory 11 to read out the read data from the block. Then, the MPU 22 supplies the host device 2 with the data read out from the flash memory 11.

In the memory system of the first embodiment of the present invention, logical addresses are subject to zone management, but the blocks are not, which allows any unused block to be assigned to write data. Therefore, all blocks in the flash memory are uniformly used, avoiding concentration of writing into a particular block. As a result, reaching a write number limit in a particular block much earlier than other blocks can be avoided.

### Second Embodiment

The second embodiment involves using only one of the flash memories predetermined in accordance with a logical address of write data in addition to the features of the first embodiment.

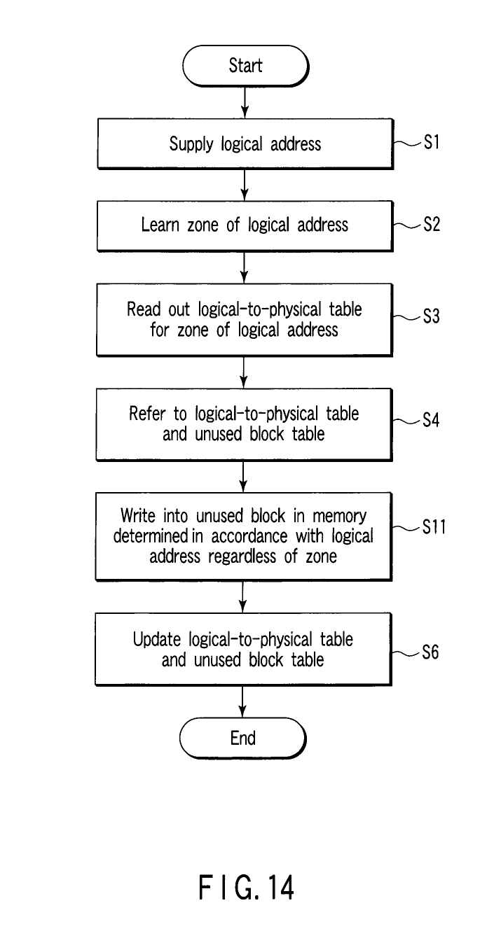

Referring to FIGS. 11 to 14, a description will be given of a memory system (memory card) of the second embodiment of the present invention. FIGS. 11 to 14 are block diagrams each of which shows a state of the memory system (memory card) of the second embodiment of the present invention during writing. FIG. 14 is a flowchart of writing of the second embodiment. FIGS. 11 to 13 partly show components necessary for explanation of the second embodiment, among those shown in FIG. 3.

When the memory system 1, for example, receives power from the host device 2 or receives a first write command after a start of application of the power, the MPU 22 creates an unused block table on the RAM 25 before writing as in the first embodiment. The unused block table may be provided for each flash memory 11a and 11b and stored in flash memory 11a and 11b.

Next, as shown in FIGS. 11 and 14, the MPU 22 receives write data and its logical address from the host device (step S1). Then, the MPU 22 uses the logical address to learn a zone to which the logical address belongs (step S2).

Then, the MPU 22 reads out a logical-to-physical table for the zone to which the logical address of the write data belongs (target logical-to-physical table) from the flash memory 11 to the RAM 25 (step S3).

As described, the logical-to-physical table is provided for each zone and is stored in the flash memory 11, as in the first embodiment.

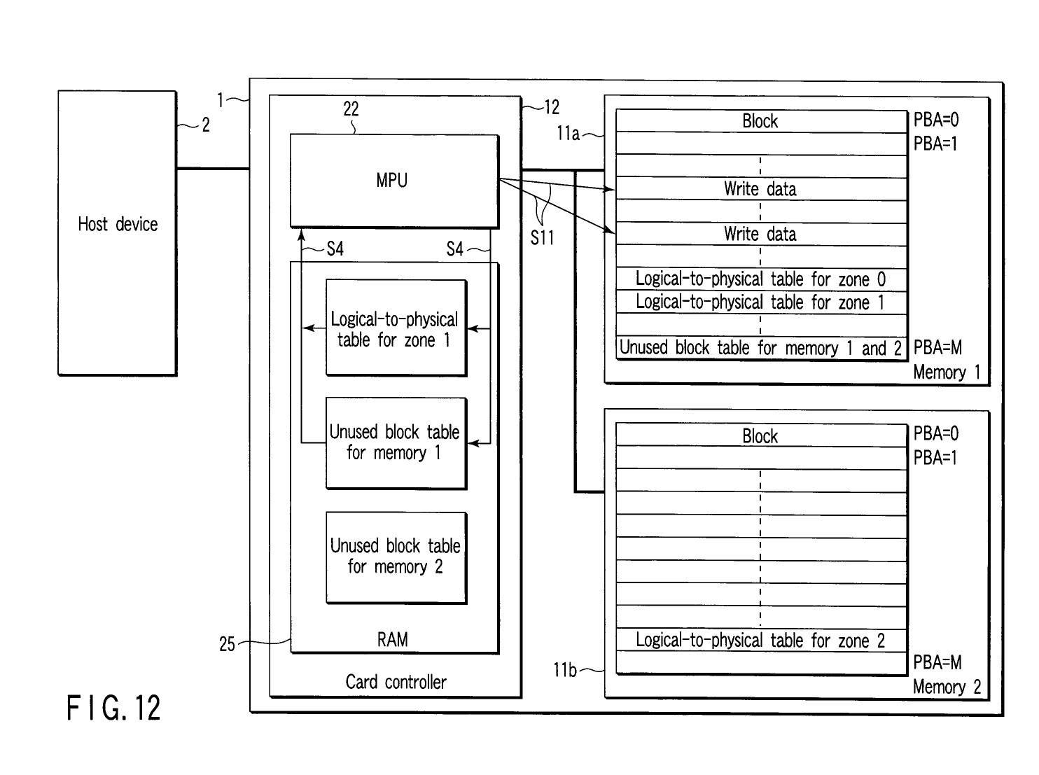

Next, as shown in FIGS. 12 and 14, the MPU 22 refers to the unused block table and the target logical-to-physical table (step S4). Then, the MPU 22 assigns an unused block to the write data and carries out an operation to write data into the assigned block (step S11). More specifically, the MPU 22 accesses the unused block table and the logical-to-physical table created on the RAM 25, searches for an unused block, and learns an address of the unused block. Then, the MPU 22 assigns one or more unused blocks to write data in accordance with the size of the write data.

Each flash memory 11a and 11b has its own unused block table. For this reason, candidate blocks to be assigned to the write data is selected from only one of the flash memories 11a and 11b in accordance with the logical address of the write data. Criteria for selection of flash memory 11a or 11b may be whether a logical address has an even number or an odd number. More specifically, blocks in the flash memory 11a may be used for even-number logical addresses and blocks in the flash memory 11b may be used for odd-number logical addresses.

Then, the MPU 22 refers to the unused block table of the selected flash memory 11a or 11b to search for an unused block. Target blocks for searching are all blocks of flash memory 11a or all blocks of flash memory 11b, and are not associated with the zone of the write data as in the first embodiment. Therefore, candidate blocks used for writing of write data with even-number logical addresses are all unused blocks of the flash memory 11a and for writing of write data with odd-number logical addresses, are all unused blocks of the flash memory 11b.

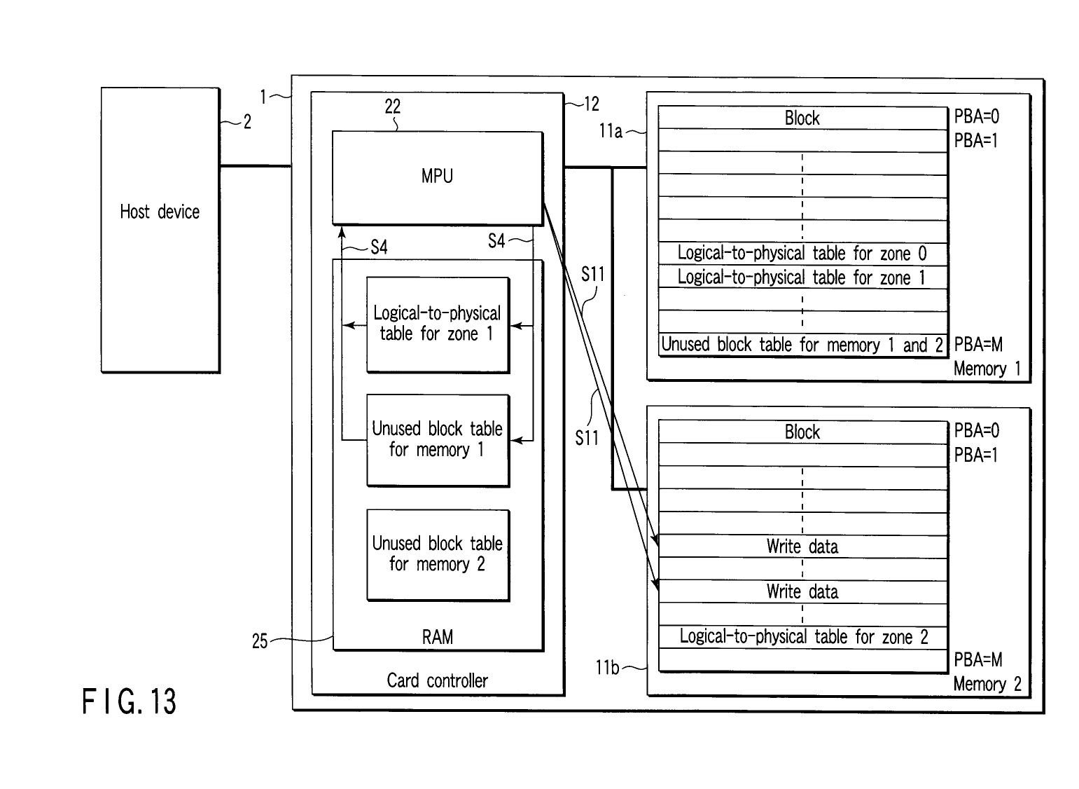

Then, the MPU 22 instructs the flash memory 11 to write write data into the assigned block. The flash memory responds to the instruction to write write data into the designated block. FIG. 12 shows a state of the memory system during writing of write data into the flash memory 11a. FIG. 13 shows a state of the memory system during writing of write data into the flash memory 11b.

As described, the MPU 22 classifies logical addresses into zones to manage them and does not classify the blocks to manage them. In other words, restrictions are not imposed as to which block should store the write data within each flash memory 11a and 11b. Therefore, the MPU 22 can assign any unused block to write data regardless of a zone of the write data as long as the assigned block is within one of the flash memories 11a and 11b determined in accordance with the logical address.

As shown in FIG. 14, the MPU 22 updates the target logical-to-physical table and the unused block table in accordance with the logical address of the write data (step S6).

The logical-to-physical table and the unused block table on the RAM 25 are written into the flash memory 11 if necessary as in the first embodiment.

Reading operation remains the same as that of conventional zone management methods, as in the first embodiment.

In the memory system of the second embodiment of the present invention, write data is written into any unused block with no particular restriction as long as it is within the predetermined flash memory 11a or 11b. Therefore, the same advantages as the first embodiment can be obtained.

Further, in the second embodiment, write data is written into one of the flash memories 11a and 11b determined in accordance with its logical address. Therefore, write data with a particular logical address is always written in the same one of the flash memory 11a and 11b. For this reason, a page copy command, which the flash memories 11a and 11b generally support, can be used for the copy-involved writing. The page-copy command can carry out copying of data within a flash memory. Using the page-copy command can achieve a higher operation necessary for the copy-involved writing than using read command and write command to perform it.

### Third Embodiment

The third embodiment involves provision of a logical-to-physical table dedicated to particular logical addresses.

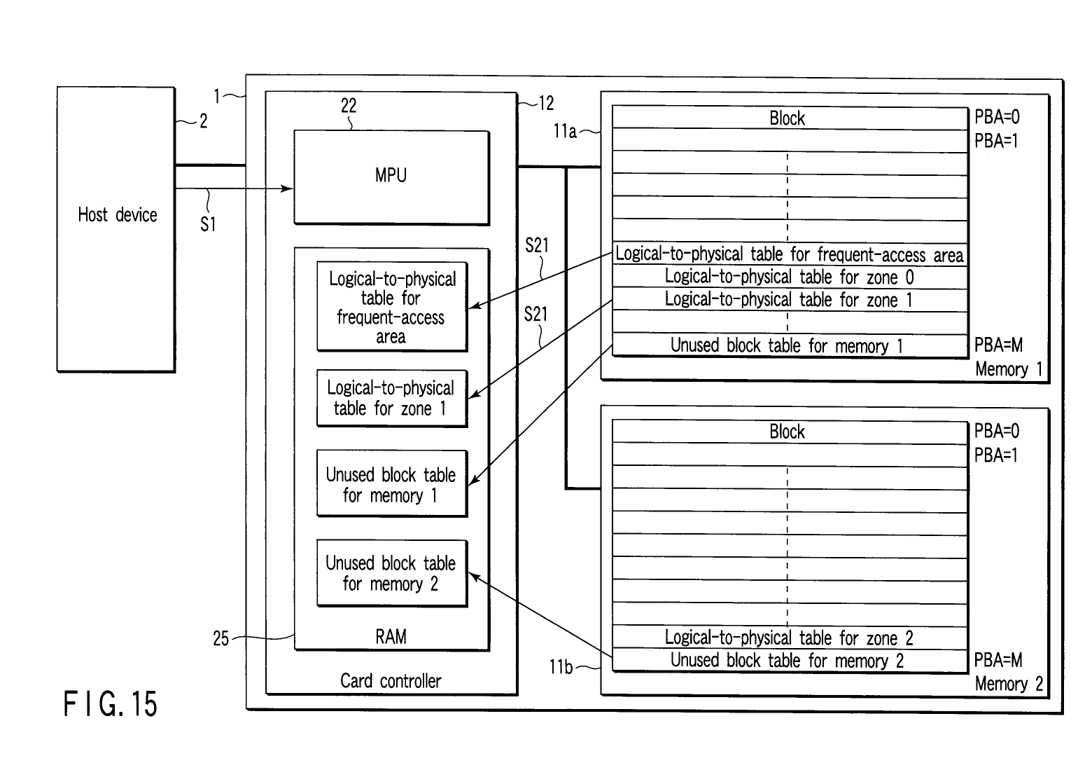

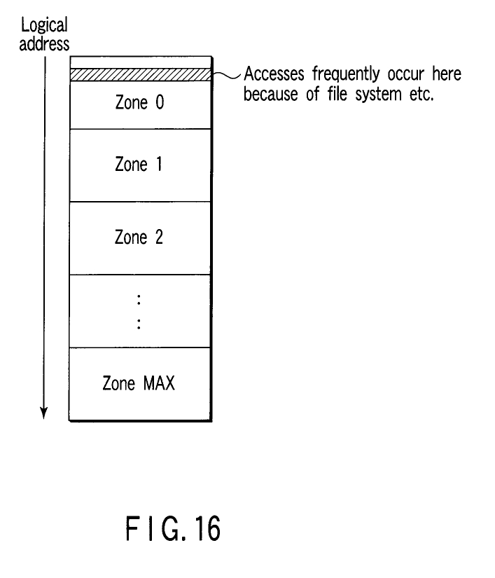

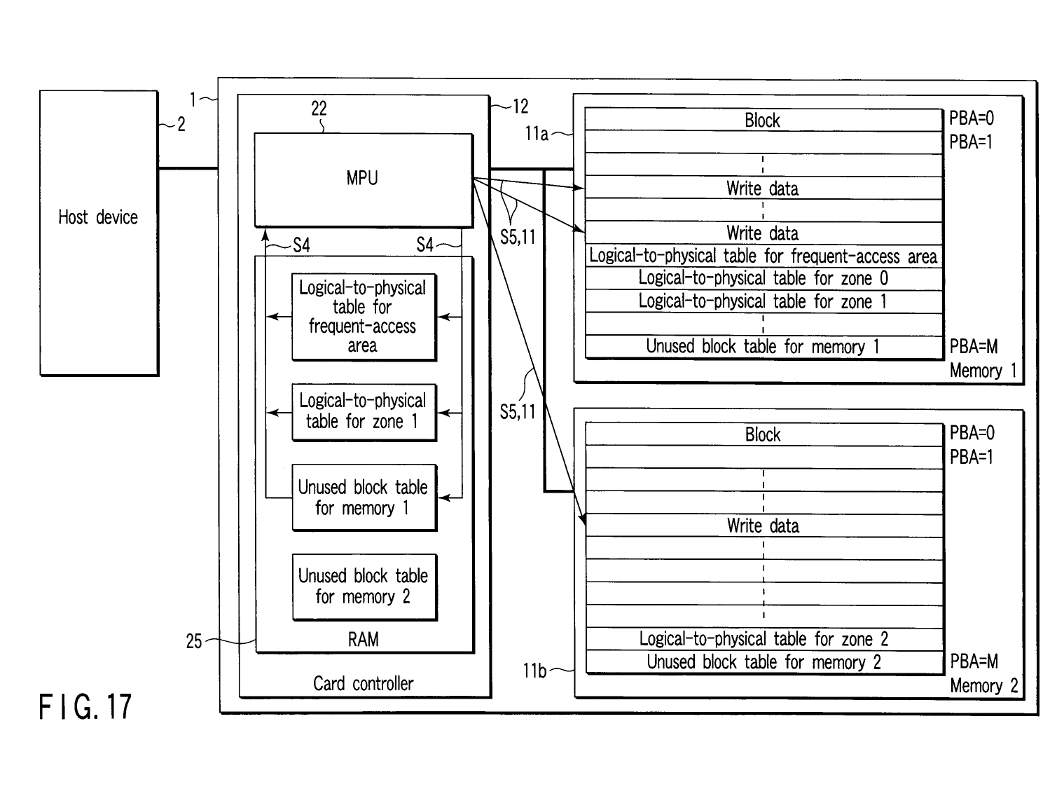

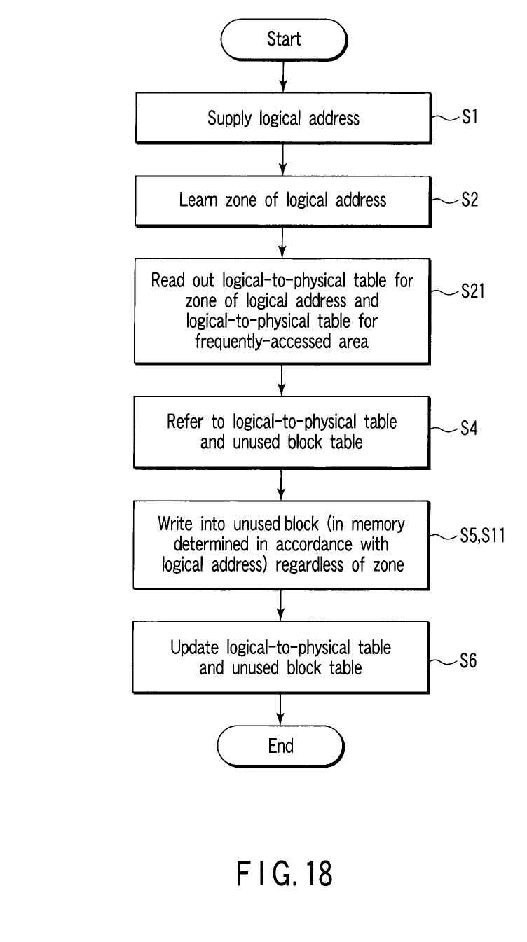

Referring to FIGS. 15 to 18, a third embodiment of a memory system (memory card) of the present invention will be described. FIGS. 15 and 17 are block diagrams each of which shows a state of the memory system (memory card) of the third embodiment during writing. FIG. 18 is a flowchart for writing of the memory card of the third embodiment. FIGS. 15 and 17 partly show components necessary for explanation of the third embodiment, among those shown in FIG. 3.

First, when the memory system 1, for example, receives power from the host device 2 or receives a first write command after a start of application of power, the MPU 22 creates an unused block table on the RAM 25 before writing as in the first embodiment. The unused block tables may be provided for each flash memory 11a and 11b and stored in respective flash memories 11a and 11b.

Next, as shown in FIGS. 15 and 18, the MPU 22 receives write data and its logical address from the host device (step S1). Then, the MPU 22 uses the logical address to learn a zone to which the logical address belongs (step S2).

Then, the MPU 22 reads out a logical-to-physical table for the zone to which the logical address of the write data belongs (target logical-to-physical table) from the flash memory 11 to the RAM 25 (step S3).

The MPU 22 also creates a logical-to-physical table for an area including logical addresses whose data is frequently requested to be written on the RAM 15. The area, which is called hereinafter a frequent-access area, may be as follows.

Some file system employed by the host device 2 sends an update request on file system information to the memory system 1 after a write request. The file system information update occurs, for example, after writing into predetermined number of pages. The MPU 22 uses a logical address of the file system information to learn the zone to which the file system information belongs.

Note that example file system information includes FAT #1, FAT #2 and a directory entry for FAT 16.

The file system information is labeled with the same logical addresses for the same file system of the host device 2. The most common example may be the file system information labeled with a predetermined number of logical addresses from the lowest one. For this reason, the logical-to-physical table for the zone to which the file system information belongs needs to be created on the RAM 25 for every data writing. Therefore, such a logical-to-physical table is separated from that for the zone to which the file system information belongs. With this configuration, the logical-to-physical table for the zone to which the file system information belongs may or may not contain a correspondence between the logical addresses for the file system information and the physical addresses.

After the MPU 22 reads out the logical-to-physical table for the frequent-access area from the flash memory 11 to store and keeps it on the RAM 25. The MPU 22 reads out and writes only the logical-to-physical table for logical addresses for actual data from and into the flash memory 11. The MPU 22 stores the logical-to-physical table for the frequent-access area in a predetermined block in the flash memory 11 before, for example, cutting off the power to the memory system 1.

As described, since the third embodiment provides each logical address/physical table for each zone as in the first embodiment, each logical-to-physical table for each zone of the write data is stored in the flash memory 11. Further, the logical-to-physical table for the frequent-access area is also stored in the flash memory 11.

Next, as shown in FIGS. 17 and 18, the MPU 22 refers to the unused block table and the logical-to-physical table (step S4). Then, the MPU 22 assigns an unused block to the write data and carries out operation to write data into the assigned block (step S5 or S11). Any particular assignment can be used. For example, using the assignment described in the first or second embodiments can provide advantages of the first or second embodiments.

Then, the MPU 22 instructs the flash memory 11 to write write data into the assigned block.

As shown in FIG. 18, the MPU 22 updates the target logical-to-physical table and the unused block table in accordance with the logical address of the write data (step S6).

The logical-to-physical table and the unused block table on the RAM 25 are written into the flash memory 11, if necessary, as in the first embodiment.

Reading operation remains the same as that of conventional zone management methods, as in the first embodiment.

In the memory system according to the third embodiment, the write data is written into a block without any restriction imposed. Therefore, the same advantages as the first embodiment can be obtained.

In the third embodiment, the logical-to-physical table for one or more logical addresses for the file system information etc., which are frequently accessed, is independently or redundantly provided from a logical-to-physical table for a zone for the logical addresses. This allows the logical-to-physical table for the frequent-access area to stay on the RAM 25, which can eliminate the necessity of reading and writing the logical-to-physical table for the frequent-access area from and into the flash memory 11, realizing faster operation of the memory system 1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system that is configured to receive write data each labeled with a logical address from a host device, the system comprising:
a nonvolatile semiconductor memory storing data in units of a first unit area and erasing data in units of a second unit area, each of second unit areas consisting of a predetermined number of first unit areas;
a controller classifying the logical address of the write data into one of management units in accordance with the logical address, managing correspondence information that shows a correspondence between logical addresses of stored data and second unit areas that store corresponding write data for each of the management units, and assigning to the write data one of the second unit areas that have at least as large address space as an address space of logical addresses belonging to two or more of the management units.

2. The system according to claim 1, wherein:
one of the second unit areas stores the correspondence information for one of the management units; and
the controller reads out the correspondence information for one of the management units to which target data for reading or writing belongs in accordance with a logical address of the target data.

3. The system according to claim 1, wherein the memory system is a memory card.

4. The system according to claim 1, wherein the semiconductor memory is a NAND type flash memory.

5. A memory system that is configured to receive write data each labeled with a logical address from a host device, the system comprising:
a nonvolatile first semiconductor memory and a nonvolatile second semiconductor memory each storing data in units of a first unit area and erasing data in units of a second unit area, each of second unit areas consisting of a predetermined number of first unit areas; and
a controller assigning to the write data one of the second unit areas that belong to only one of the first semiconductor memory and the second semiconductor memory determined in accordance with the logical address of the write data and that have at least as large address space as an address space of logical addresses belonging to two or more of the management units.

6. The system according to claim 5, wherein the controller writes the write data labeled with an even-number logical address into the first semiconductor memory, and the write data labeled with an odd-number logical address into the second semiconductor memory.

7. The system according to claim 6, wherein:
the controller classifies the logical address of the write data into one of management units in accordance with the logical address;
the controller manages correspondence information that shows a correspondence between logical addresses of stored data and second unit areas that store corresponding data for each of the management units;
one of the second unit areas stores the correspondence information for one of the management units; and
the controller reads out the correspondence information for one of the management units to which target data for writing or reading belongs in accordance with a logical address of the target data.

8. The system according to claim 5, wherein the memory system is a memory card.

9. The system according to claim 5, wherein each of the first and second semiconductor memories is a NAND type flash memory.

10. A memory system that is configured to receive write data that contains actual data or management data to manage actual data and is labeled with a logical address from a host device, the system comprising:
a nonvolatile semiconductor memory storing data in units of a first unit area and erasing data in units of a second unit area, each of second unit areas consisting of a predetermined number of first unit areas; and
a controller assigning to the write data one of the second unit areas that contain no valid data and creating a management data correspondence information that shows correspondence between logical addresses of stored data containing the management data and second unit areas that store corresponding data containing the management data.

11. The system according to claim 10, wherein the controller:
creates an actual-data correspondence information which shows a correspondence between logical addresses of stored data containing the actual data and second unit areas that store corresponding data containing the actual data; and
individually creates the actual-data correspondence information and the management-data correspondence information.

12. The system according to claim 10, wherein:
one of the second unit areas stores the actual-data correspondence information for one of the management units; and
the controller reads out the actual-data correspondence information for one of the management units to which target data for reading or writing belongs in accordance with a logical address of the target data.

13. The system according to claim 10, wherein the controller includes a temporary memory device on which the management-data correspondence information is kept.

14. The system according to claim 10, wherein the memory system is a memory card.

15. The system according to claim 10, wherein the semiconductor memory is a NAND type flash memory.
